(19) United States
(12) Patent Application Publication
(10) Pub. No.: US 2015/0168354 A1
(43) Pub. Date: Jun. 18, 2015

(54) PROBE AND SAMPLE INFORMATION ACQUISITION DEVICE

(71) Applicant: CANON KABUSHIKI KAISHA, Tokyo (JP)

(72) Inventor: Atsushi Kandori, Ebina-shi (JP)

(21) Appl. No.: 14/565,215

(22) Filed: Dec. 9, 2014

(30) Foreign Application Priority Data
Dec. 12, 2013 (JP) 2013-257165

(51) Int. Cl. G01N 29/24; G01N 29/02

(52) U.S. Cl. CPC G01N 29/2418; G01N 29/02; G01N 2291/044; G01N 2291/023; G01N 2291/022

(57) ABSTRACT

Provided is a probe which includes: an element configured to receive an acoustic wave generated within a sample upon irradiation of light; a first light reflective film; and an acoustic lens, wherein the first light reflective film is provided between the element and the acoustic lens and reflects light of a bandwidth including a wavelength of light with which the sample is irradiated.

### BACKGROUND OF THE INVENTION

1. Field of the Invention

The present invention relates to a probe and a sample information acquisition device. More particularly, the present invention relates to a probe for receiving an acoustic wave generated upon irradiation of light and a sample information acquisition device provided with the probe.

2. Description of the Related Art

For at least one of transmission and reception of an acoustic wave (typically, an ultrasonic wave), a capacitive micromachined ultrasonic transducer (CMUT) which is a capacitive transducer has been proposed. The CMUT is manufactured using a micro electro mechanical systems (MEMS) process to which a semiconductor process is applied. In the CMUT, the minimum unit provided with a first electrode and a second electrode disposed to face the first electrode across a gap (i.e., a cavity) is referred to as a cell, and the second electrode side is configured to be vibratable. A collection of a plurality of cells is referred to as an element.

There has been a technique called photoacoustic imaging (PAI) as one of optical imaging techniques. The photoacoustic imaging is a technique to receive an acoustic wave generated upon irradiation of light (referred also to as a “photoacoustic wave”) and generate image data from obtained reception signals. The photoacoustic wave is generated in the following manner: pulsed light from a light source is applied to a sample and tissues which have absorbed energy of light that propagating through the sample expand. U.S. Patent Application Publication No. 2007-0287912 discloses a CMUT which receives such a photoacoustic wave.

### SUMMARY OF THE INVENTION

In a case in which an element receives a photoacoustic wave, when emitted light is applied to an element surface, a transducer may absorb the light and generate a photoacoustic wave. The photoacoustic wave generated from an element surface may become a noise to a photoacoustic wave from a sample.

An object of an embodiment of the present invention is to reduce a noise by a photoacoustic wave generated from an element.

A probe according to an embodiment of the present invention is a probe which includes: an element configured to receive an acoustic wave generated within a sample upon irradiation of light; a first light reflective film; and an acoustic lens, wherein the first light reflective film is provided between the element and the acoustic lens and reflects light of a bandwidth including a wavelength of light with which the sample is irradiated.

A probe according to another embodiment of the present invention is a probe, which includes: an element configured to receive an acoustic wave generated within the sample upon irradiation of light; a first light reflective film; and a protective layer, wherein the first light reflective film is provided between the element and the protective layer and reflects light of a bandwidth including a wavelength of light with which the sample is irradiated.

Further features of the present invention will become apparent from the following description of exemplary embodiments with reference to the attached drawings.

### BRIEF DESCRIPTION OF THE DRAWINGS

FIG. 1 is a schematic diagram illustrating a probe according to a first embodiment.

FIG. 2 is a schematic diagram illustrating a probe according to a second embodiment.

FIG. 3 is a schematic diagram illustrating a probe according to a third embodiment.

FIG. 4 is a schematic diagram illustrating a probe according to a fourth embodiment.

FIG. 5 is a schematic diagram illustrating a probe according to a fifth embodiment.

FIGS. 6A and 6B are schematic diagrams illustrating probes according to a sixth embodiment.

FIG. 7 is a schematic diagram illustrating a probe according to a seventh embodiment.

FIG. 8 is a schematic diagram illustrating a probe according to an eighth embodiment.

FIG. 9 is a schematic diagram illustrating an apparatus according to a ninth embodiment.

FIG. 10 is a schematic diagram illustrating an apparatus according to a tenth embodiment.

FIG. 11 is a schematic diagram illustrating Comparative Example.

FIG. 12 is a schematic diagram illustrating a capacitive transducer.

### DESCRIPTION OF THE EMBODIMENTS

Hereinafter, embodiments of the present invention will be described with reference to the drawings. The same component will be denoted by the same reference numeral and description thereof will be omitted. A probe according to an embodiment of the present invention includes a light reflective film, and a position at which the light reflective film is disposed is focused on. In this specification, for the convenience of description, an acoustic wave generated upon absorption of light may sometimes be referred to as a “photoacoustic wave” and an acoustic wave transmitted from an element and a reflected wave of this transmitted acoustic wave which is reflected and returned may sometimes be referred to as an “ultrasonic wave.”

### First Embodiment

### Configuration of Probe

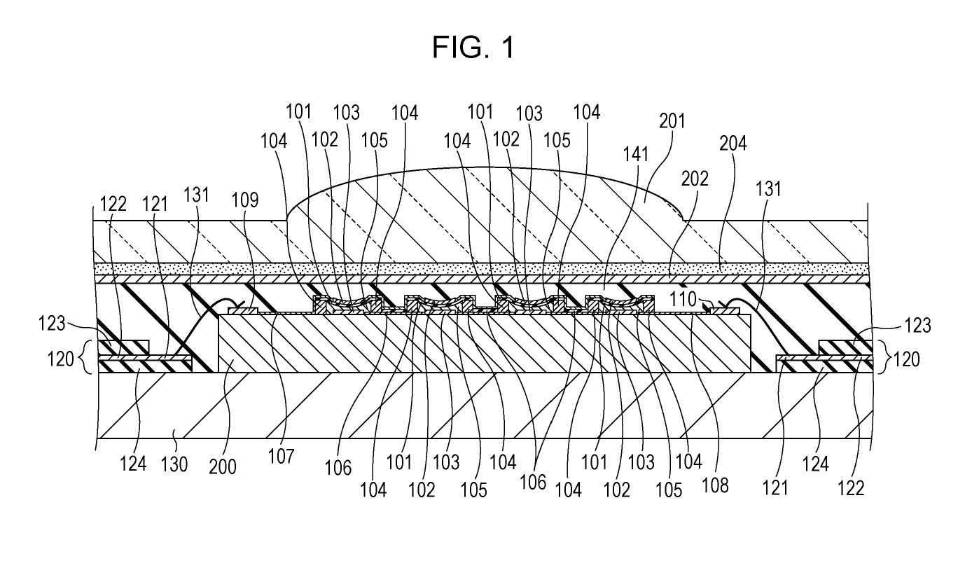

A probe of the present embodiment includes a capacitive transducer element capable of at least one of transmitting and receiving an ultrasonic wave and capable of receiving a photoacoustic wave. A configuration of the probe of the present embodiment will be described with reference to FIG. 1. FIG. 1 is a schematic diagram illustrating a part of a cross section of the probe of the present embodiment. An outer peripheral side of the probe is not illustrated.

The probe of the present embodiment includes an element chip 200, a light reflective film 202 and an acoustic lens 201. The element chip 200 is provided on a support member 130. First electrodes 103 provided in cells in the element chip 200 are electrically connected to an electrode pad 110 via wiring 108. The electrode pad 110 is connected to a flexible wiring substrate 120 by a wire 131. Second electrodes 102 are electrically connected to an electrode pad 109 via wiring 107. The electrode pad 109 is connected to a flexible wiring substrate 120 by a wire 131.

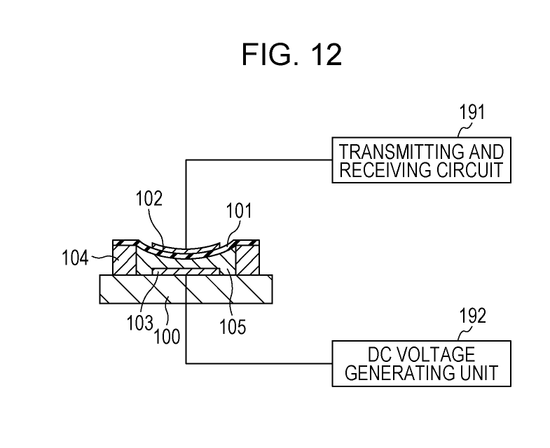

The flexible wiring substrate 120 includes a conductive layer 122 which is disposed between an insulating layer 123 and an insulating layer 124, and an electrode pad 121 which is electrically connected to a conductive layer 122. The electrode pad 110 of the element chip 200 and the electrode pad 121 of the flexible wiring substrate 120 are electrically connected by the wire 131. Although the conductive layer 122 for the first electrode 103 and the conductive layer 122 for the second electrode 102 are provided in separate flexible wiring substrates 120 in FIG. 1, these conductive layers 122 may be disposed in a common flexible wiring substrate 120 in the present embodiment. That is, as long as the conductive layer 122 for the first electrode 103 and the conductive layer 122 for the second electrode 102 are insulated electrically, the conductive layer 122 for the first electrode 103 and the conductive layer 122 for the second electrode 102 may be disposed in the same flexible wiring substrate 120. The conductive layer(s) 122 in the flexible wiring substrate 120 are connected to a DC voltage generating unit 192 (see FIG. 12) and a transmitting and receiving circuit 191 (see FIG. 12).

### Configuration of Element

The element chip 200 includes an element provided with one or more cells. FIG. 12 is an enlarged view of a cell. The cell is a configuration of the minimum unit supported so that a vibration membrane including one of a pair of electrodes provided via a cavity 105 which is a gap is vibratable. In FIG. 1, the first electrode 103 and the second electrode 102 are provided via the cavity 105 and the vibration membrane includes a membrane 101 and the second electrode 102. The vibration membrane is supported by a vibration membrane support portion 104.

The element refers to an electrically independent one constitutional unit provided with one or more cells. That is, in a case in which one cell is considered as a capacity, capacities in a plurality of cells in the element are connected electrically in parallel and signals are input and output in element units. Although the element includes four cells in FIG. 1, the number of cells in the present embodiment is not limited to the same.

Although the number of element is one in FIG. 1, the number of the element is not limited to the same and a plurality of elements may be provided in the present embodiment. In a case in which a plurality of elements are provided, those elements are electrically separated from one another. In particular, it is necessary that at least one of the first electrode 103 and the second electrode 102 is electrically separated in each element. The electrode electrically separated in each element functions as an individual electrode. The individual electrode is connected to the transmitting and receiving circuit 191 (see FIG. 12) and may be used to drive each element or take out an output of each element. The other of the first electrode 103 and the second electrodes 102 may be a common electrode which is electrically connected to a plurality of elements or may be an individual electrode separated in each element.

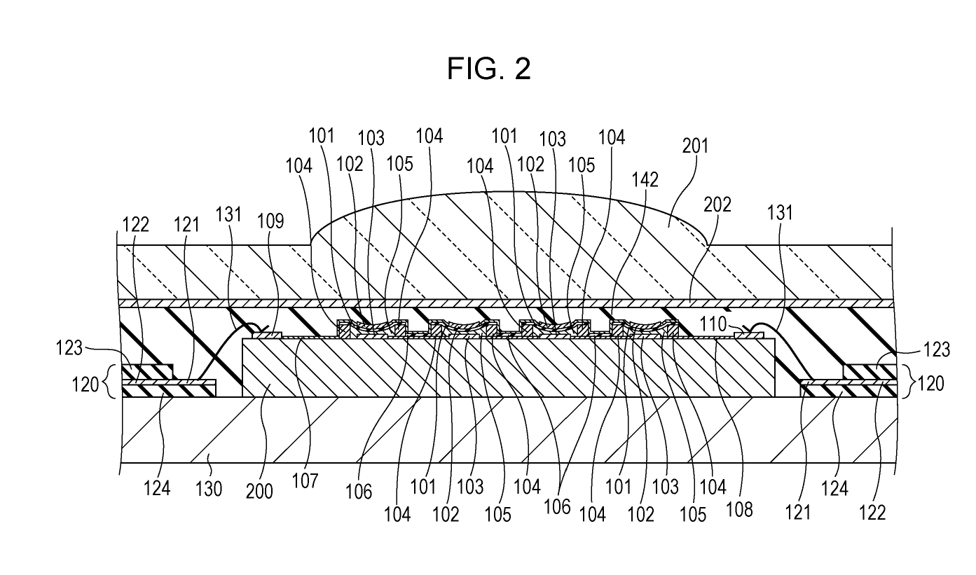

Although the vibration membrane consists of the membrane 101 and the second electrode 102 in FIG. 2, it is only necessary that the vibration membrane at least includes the second electrode 102 and is vibratable.

Although the first electrode 103 is directly provided on the substrate in the present embodiment, an insulating film may be provided between the first electrode 103 and the substrate. An insulating film may be provided on the first electrode 103.

A silicon substrate, a glass substrate and the like may be used as the substrate on which the element is provided. As the first electrode 103 and the second electrode 102, metal, such as titanium and aluminum, aluminum silicon alloy and the like may be used. As the insulating film 106 and the membrane 101, a silicon nitride film, a silicon oxide film and the like may be used. The cell may be fabricated by publicly known methods, such as a sacrificial layer method in which a sacrificial layer is etched to form a cavity, and a bonding method in which an active layer (i.e., a surface silicon layer) of an SOI substrate is used as a membrane.

### Driving Principle of Element

A driving principle of the element of the present embodiment will be described. The probe of the present embodiment is capable of receiving a photoacoustic wave and transmitting and receiving an ultrasonic wave. Since reception of the ultrasonic wave (i.e., the reflected wave) and reception of the photoacoustic wave are basically the same operation, a driving method at the time of receiving the ultrasonic wave and a driving method at the time of transmitting the ultrasonic wave will be described below.

When the element receives an ultrasonic wave, voltage values of the first electrode 103 and the second electrode 102 are fixed to respective predetermined values so that a potential difference is produced between the first and second electrodes. For example, in a case in which the first electrode 103 is used as the common electrode and the second electrode 102 is used as the individual electrode, a DC voltage Va is applied to the first electrode 103 from the DC voltage generating unit 192 and the second electrode 102 is fixed to a ground potential Vg.

The ground potential Vg in the present invention refers to a DC reference potential which the transmitting and receiving circuit 191 has.

In this manner, the potential difference of Vbias=Va−Vg is generated between the first electrode 103 and the second electrode 102. When the ultrasonic wave is received in this state, since the vibration membrane including the second electrode 102 which is the individual electrode vibrates, a distance between the second electrode 102 and the first electrode 103 changes and an electric capacity changes. As a result of this capacity change, signals (i.e., a current) are output for each element from the second electrode 102.

This current is input in the transmitting and receiving circuit 191 via the flexible wiring substrate 120. The transmitting and receiving circuit 191 converts the current into a voltage and transmits the voltage to an external signal processing unit as reception signals.

In a case in which the ultrasonic wave is to be transmitted, in a state in which a potential difference is produced between the first electrode 103 and the second electrode 102, an AC voltage and a pulse voltage which are transmission signals are supplied to the second electrode 102 from the transmitting and receiving circuit 191. Alternatively, a voltage in which an AC voltage is superimposed on a DC voltage (that is, an AC voltage of which positive/negative is not inverted) is supplied to the second electrode 102 as a transmitted signal from the transmitting and receiving circuit 191. The electrostatic force by the transmitted signals causes the vibration membrane to vibrate and causes the ultrasonic wave to be independently transmitted for each element.

In the foregoing, although the DC voltage generating unit 192 is connected to the first electrode 103 and the transmitting and receiving circuit 191 is connected to the second electrode 102, the DC voltage generating unit 192 may be connected to the second electrode 102 and the transmitting and receiving circuit 191 may be connected to the first electrode 103.

### Acoustic Lens 201

The probe of the present embodiment includes an acoustic lens 201 at an upper portion (i.e., a sample side) of the element. The acoustic lens 201 may converge (i.e., narrow) the ultrasonic waves transmitted from each element and may increase sound pressure in an area near a central axis of the transmitted ultrasonic wave. The transmitted ultrasonic wave is reflected within the sample and the probe receives the reflected wave which has been reflected and returned. At this time, since the acoustic lens 201 is provided, receiving sensitivity of the ultrasonic wave returning from an area near the central axis of the transmitted ultrasonic wave may be increased as compared with that of the ultrasonic wave returning from other areas. Therefore, since detection sensitivity to an inspection target of an area near the central axis (i.e., an inspection target by the ultrasonic wave) may be increased as compared with other areas, resolution of the area near the central axis may be increased.

An acoustic impedance of the acoustic lens 201 is desirably close to that of a living body and, specifically, is desirably from equal to or greater than 1 MRayls to equal to or less than 2 MRayls. More desirably, the acoustic impedance is around 1.5 MRayls (i.e., in an error range of the acoustic impedance of equal to or less than ±10% of 1.5 MRayls).

A thickness of the acoustic lens 201 is determined depending on a curvature of a necessary lens and commonly is from equal to or greater than 10 μm to equal to or less than 1 mm.

It is desirable that the acoustic lens 201 of the present embodiment is transparent to light of a wavelength band used to generate a photoacoustic wave. That is, it is desirable to let light of the used wavelength band pass through without being absorbed. Specifically, the acoustic lens 201 of the present embodiment has transmittance of light of a wavelength band used to generate a photoacoustic wave of desirably equal to or greater than 80% and, more desirably, equal to or greater than 90%.

The acoustic lens 201 of the present embodiment has an absorption coefficient of less than 0.2 mm⁻¹ in the wavelength band of light used. Therefore, light absorbed when the thickness of the acoustic lens 201 is 0.5 mm may be reduced to about 20%. The acoustic lens 205 of the present embodiment desirably has an absorption coefficient less than 0.1 mm⁻¹ in the wavelength band of light used. Therefore, light absorbed when the thickness of the acoustic lens 201 is 0.5 mm may be reduced to about 10%.

An absorption coefficient of hemoglobin which is a typical optical absorber (i.e., an inspection target by a photoacoustic wave) to a bandwidth of about 600 nm to about 1000 nm which is considered to be a wavelength band of light used is from equal to or greater than 0.3 mm⁻¹ to equal to or less than 0.9 mm⁻¹. Also from this viewpoint, it is desirable to set the absorption coefficient of the acoustic lens 201 to less than 0.2 mm⁻¹, whereby the absorption coefficient of the acoustic lens 201 becomes smaller than the absorption coefficient of hemoglobin. Since laser light having a peak on a predetermined wavelength is often used to generate a photoacoustic wave, in this case, an absorption coefficient of the acoustic lens 201 indicates to be less than 0.2 mm⁻¹ on the peak wavelength.

More desirably, the absorption coefficient of the acoustic lens 201 of the present embodiment is less than 0.01 mm⁻¹. Therefore, light to be absorbed by the acoustic lens 201 may be reduced to about less than 1%. An optical absorption coefficient of a living body (i.e., adipose tissues) is from equal to or greater than about 0.005 mm⁻¹ to equal to less than about 0.02 mm⁻¹ in a light wavelength bandwidth of 600 nm to 1100 nm. Also from this viewpoint, by setting the optical absorption coefficient of the acoustic lens 201 to substantially the same or below the optical absorption coefficient of the sample, signals which become a noise component to the photoacoustic wave from the optical absorber which is an inspection target may be reduced.

As materials of the acoustic lens 201, silicone rubber having polydimethylsiloxane (PDMS) as a principal component crosslinked with an organic polymer, and resin are desirably used. PDMS to which silica particles are added and fluorosilicone of which hydrogen of PDMS is partially replaced with fluoride may also be used. However, silicone rubber used in a typical ultrasonic probe is colored white and gray and thus absorbs light to some extent. If such silicone rubber is used for an acoustic lens, there is a possibility that light is absorbed by the acoustic lens and a photoacoustic wave is generated, whereby a noise of the photoacoustic wave is generated from the inspection target. Therefore, it is desirable to use a material having optical property as that of the present embodiment.

### Light Reflective Film 202

In the present embodiment, an acoustic matching layer 141 is formed on the element chip 200, and the light reflective film 202 is disposed to cover the element. An adhesive layer 204 is disposed on the light reflective film 202, and the acoustic lens 201 is disposed thereon. That is, the probe includes the light reflective film 202 provided between the element and the acoustic lens 201.

The light reflective film 202 may reflect light of a wavelength emitted from a light source in order to generate a photoacoustic wave. Therefore, light which has passed through the acoustic lens 201 and reached the light reflective film 202 may be reflected on the light reflective film 202, whereby and generation of the photoacoustic wave in the light reflective film 202 and generation of the photoacoustic wave in the element may be reduced. The light reflected on the light reflective film 202 passes through the acoustic lens 201 again and goes outside the probe. Therefore, even if a part of the light applied to the sample enters the probe, generation of the photoacoustic wave inside the probe may be reduced.

In an area near the light reflective film 202, mismatch of the acoustic impedance is likely to occur. Although the light reflective film 202 should have a certain degree of thickness to reflect light, an excessively large thickness may cause reflection of an ultrasonic wave and a photoacoustic wave. Therefore, it is desirable that the thickness of the light reflective film 202 is set to from equal to or greater than the wavelength of light to equal to or less than 1/16 of the wavelength λ of an ultrasonic wave of the maximum frequency to be transmitted and received. More desirably, the thickness is set to equal to or less than 1/32 of the wavelength λ.

For example, in a case in which Au is used, since the acoustic impedance is about 63×106 [kg·m⁻²·s⁻¹,] and a frequency of the ultrasonic wave is about 10 MHz (a wavelength is about 150 μm), the thickness of the Au membrane is desirably equal to or less than 5 μm. Desirably, the thickness is equal to or greater than 500 nm to reflect light.

Since the light reflective film 202 of the present embodiment is provided below the acoustic lens (i.e., the element side), it is possible to dispose the light reflective film 202 to be parallel to the substrate surface of the element chip 200. That is, the light reflective film 202 and the element may be disposed so that a distance between the light reflective film 202 and the element becomes uniform in an in-plane direction. Therefore, since variation in thickness of the acoustic matching layer 141 depending on the location of the plane is reduced, damping characteristics of the acoustic wave within the acoustic matching layer 141 may be made uniform. The term “parallel” refers not only to exactly parallel but to parallel with an error that is small enough to be ignored with respect to the wavelength λ of the ultrasonic wave of the maximum frequency transmitted and received. Specifically, variation in the distance between the light reflective film 202 and the element includes an error in the in-plane direction of a range of less than 1/16 of the wavelength λ. More desirably, the variation in the in-plane direction is in a range of less than 1/32 of the wavelength λ.

It is desirable that a distance between a surface of the element (i.e., an upper surface of the vibration membrane) and the light reflective film 202 is set to be sufficiently short as compared with the wavelength λ of the ultrasonic wave (i.e., the wavelength within the acoustic matching layer 141). This is to reduce an influence of the reception signals of the reflected wave on the reception signals of the inspection target even in a case in which the transmitted ultrasonic wave is reflected on the light reflective film 202. Also on this point, in the present embodiment, since the light reflective film 202 is provided further toward the element than the acoustic lens 201, the distance between the element and the light reflective film 202 may be shortened as compared with the wavelength.

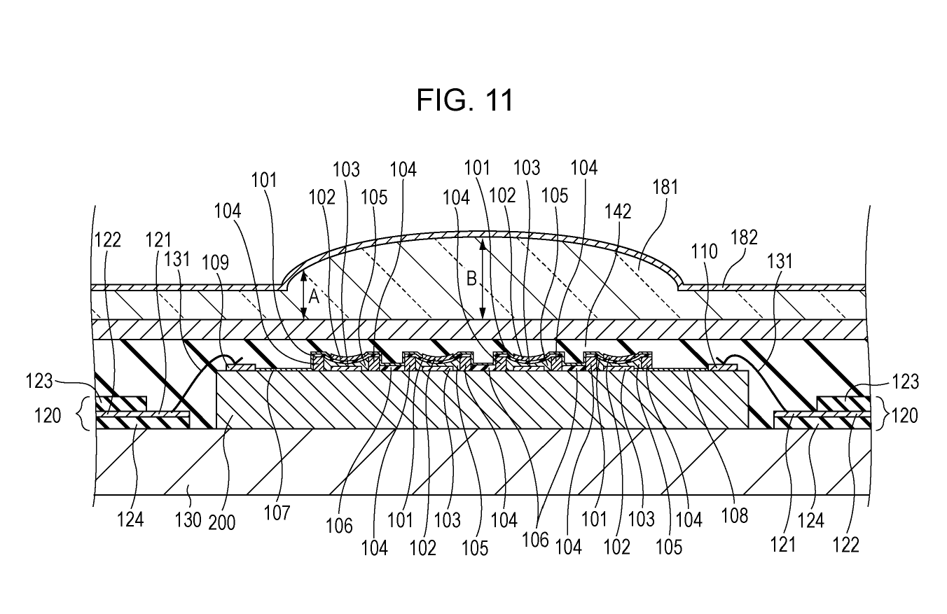

As Comparative Example, an example in which a light reflective film 182 is provided on a surface on a sample side of an acoustic lens 181 is illustrated in FIG. 11. As illustrated in FIG. 11, in a case in which the light reflective film 182 is formed on the surface of the acoustic lens 181, a distance from an element to the light reflective film 182 becomes longer by the thickness of the acoustic lens 181. Since the acoustic lens 181 is a convex lens (that is, A≠B), the distance between the element and the light reflective film 182 in the in-plane direction is not uniform. Therefore, there is a possibility that an influence of reflection of the ultrasonic wave becomes large and transmission and reception characteristics may be changed.

In the configuration of the present embodiment, in contrast, the problem of the configuration in FIG. 11 is not likely to occur, and a change in the transmission and reception characteristics due to reflection of the ultrasonic wave in an area near the light reflective film is reduced. The light reflective film 202 may be disposed further toward the element than the acoustic lens 201 as in the case in the present embodiment because of transparency of the acoustic lens 201.

Reflectance of light of a wavelength band to be used of the light reflective film 202 of the present embodiment is desirably equal to or greater than 80% and, more desirably, equal to or greater than 90%. The light reflective film 202 is desirably provided to cover a plurality of elements in the element chip 200. That is, it is desirable that, in orthogonal projection to a surface on which the element is provided (i.e., a substrate surface of the element chip 200), the light reflective film 202 is provided so that orthogonal projection of a plurality of elements are included in orthogonal projection of the light reflective film 202.

The light reflective film 202 is desirably made of a metal thin film. Specifically, metal including at least one element of Au, Ag, Al and Cu, and alloys thereof may be used. The light reflective film 202 may be formed by vapor deposition or sputtering. In order to increase adhesiveness, a base layer made of Cr or Ti may be provided. The light reflective film 202 may be made of a multilayered dielectric film instead of a metal film. A laminated structure in which a multilayered dielectric film is formed on a metal film may also be employed. It is desirable that such a laminated structure further may increase reflectance.

The light reflective film 202 of the present embodiment may be formed easily in the following manner: the acoustic matching layer 141 is applied to and cured on the element chip 200, and the light reflective film 202 is formed on the acoustic matching layer 141. Then the acoustic lens 201 is bonded to the light reflective film 202 via the adhesive layer 204. Characteristics of the adhesive layer 204 after curing is, as in the case in the acoustic lens 201, characteristics to transmit the wavelength of light.

The acoustic matching layer 141 which does not significantly differ from neighboring members or media in acoustic impedance and thus does not affect the transmission and reception characteristics may be used. Specifically, the acoustic matching layer 141 may be easily made of resin, silicone rubber and other materials. It is desirable that the acoustic matching layer 141 is electrically insulative. Specifically, the acoustic impedance is desirably from equal to or greater than 1 MRayls to equal to or less than 2 MRayls and, more desirably, a range of 1.5 MRayls±0.1 MRayls. As materials of the acoustic matching layer 141, silicone rubber having polydimethylsiloxane (PDMS) as a principal component crosslinked with an organic polymer are desirably used. PDMS to which silica particles are added and fluorosilicone of which a part of hydrogen of PDMS is replaced with fluoride may also be used. The thickness of the acoustic matching layer 141 is desirably from equal to or greater than 10 μm to equal to or less than 900 μm. By setting the thickness to be equal to or greater than 10 μm, adhesive strength between the PDMS and the element chip 200 is sufficiently secured. The Young's modulus of the acoustic matching layer 141 is desirably equal to or less than 10 MPa so that mechanical characteristics, such as deformation and the spring constant of the vibration membrane, are not changed significantly.

The adhesive layer 204 may be made of a material having an acoustic impedance sufficiently close to that of the acoustic lens 201 (desirably, a difference in acoustic impedance is equal to or less than ±30%). Specifically, the adhesive layer 204 may be easily made of resin, silicone rubber and other materials. If the material has a different acoustic impedance of that of the acoustic lens 201, such a material may also be used by reducing the thickness of the adhesive layer 204 to be sufficiently smaller than the wavelength λ of the ultrasonic wave so that an influence on the transmission and reception characteristics is substantially eliminated. Specifically, the thickness of the adhesive layer 204 is desirably equal to or less than ⅛ of the wavelength λ and, more desirably, equal to or less than 1/16 of the wavelength λ.

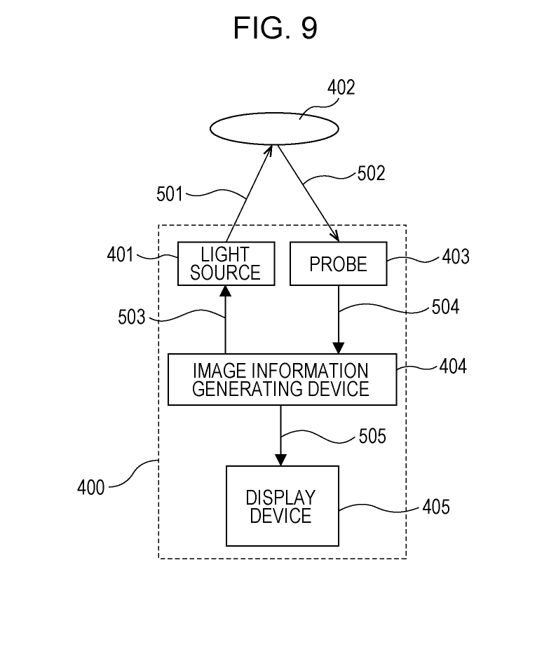

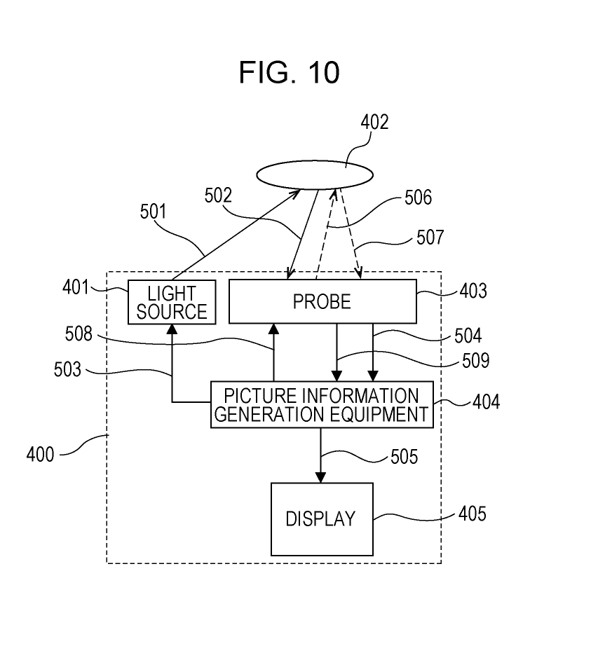

As described above, the probe of the present embodiment may provide a probe which may reduce an influence of the ultrasonic wave on transmission and reception characteristics and may reduce generation of noise by incident light. The probe of the present embodiment is capable of receiving a photoacoustic wave and transmitting and receiving an ultrasonic wave. As will be described later with reference to FIGS. 9 and 10, the probe of the present embodiment may be applied to a sample information acquisition device that obtains information in a sample by receiving an acoustic wave.

The sample information acquisition device may obtain characteristic information indicating characteristic value corresponding to each of a plurality of positions in the sample using reception signals of a photoacoustic wave generated upon irradiation of light. The characteristic information obtained by the photoacoustic wave reflect absorptivity of the optical energy. The sample information acquisition device may obtain characteristic information reflecting a difference in an acoustic impedance in the sample using reception signals of a reflected wave of a transmitted ultrasonic wave which has been reflected and returned.

Light used in the sample information acquisition device to which the probe of the present embodiment is applied may be light of a desired wavelength depending on the sample or the inspection target. In a case in which the inspection target by the photoacoustic wave is a substance in a living body, such as hemoglobin, it is desirable that the light is pulsed laser light having a wavelength band of from equal to or greater than 600 nm to equal to or less than 1100 nm.

### Second Embodiment

A second embodiment differs from the first embodiment in a configuration between an element and an acoustic lens 201. In the present embodiment, a light reflective film 202 is formed directly on the acoustic lens 201. Therefore, description of the same configurations as those of the first embodiment will be omitted and differences with the first embodiment will be described in detail.

FIG. 2 is a schematic diagram illustrating a cross section of a probe of the present embodiment. In the present embodiment, the light reflective film 202 is disposed directly on a surface of the acoustic lens 201 on an element chip 200 side without an adhesive disposed therebetween. The acoustic lens 201 on which the light reflective film 202 is formed is disposed on the element chip 200 via an acoustic matching layer 142.

The light reflective film 202 of the present embodiment may be easily formed on a surface on the element chip 200 side (i.e., a back surface) of the acoustic lens 201 by forming a light reflective film made of, for example, metal. At this time, in order to increase adhesiveness between the acoustic lens 201 and the light reflective film 202 to an extent not to affect the transmission and reception characteristics of the ultrasonic wave, surface activation or formation of a very thin film may be performed on the back surface of the acoustic lens 201. The same materials as those of the first embodiment may be used for the light reflective film 202.

The acoustic matching layer 142 of the present embodiment does not significantly differ from neighboring members or media in acoustic impedance and thus does not affect the transmission and reception characteristics as in the case in the acoustic matching layer 141 of the first embodiment. Further, the acoustic matching layer 142 of the present embodiment functions as an adhesive layer which may bond the element chip 200 and the acoustic lens 201. The acoustic matching layer 142 may be easily made of, for example, a silicone adhesive. It is desirable that a thickness of the acoustic matching layer 142 is sufficiently smaller than a wavelength λ of the ultrasonic wave. Specifically, the thickness of the acoustic matching layer 142 is desirably equal to or less than ⅛ of the wavelength λ and, more desirably, equal to or less than 1/16 of the wavelength λ. It is desirable that the acoustic matching layer 142 is made of a material having electric insulation property. However, in a configuration in which an insulating film or other film is provided on a surface of an element formed on the element chip 200 and electrode pads 109 and 110, the electrode pad 121 and a wire 131 are sealed with an insulating material, it is not necessary that the acoustic matching layer 142 is made of an electrically insulating material.

In the configuration of the present embodiment, since the light reflective film 202 is formed directly on the surface of the element chip 200 side of the acoustic lens 201, it is unnecessary to dispose an adhesive layer between the acoustic lens 201 and the light reflective film 202. Therefore, it is desirable that, since the adhesive layer is unnecessary, a decrease in transmittance and an influence on the acoustic characteristics may be reduced. As compared with a case in which a light reflective film is formed on an element chip 200 having unevenness formed on the element chip of the first embodiment via an insulating film, the light reflective film 202 may be formed on a flatter surface. Therefore, the characteristics of the light reflective film 202 are improved and a distance between the light reflective film 202 and the element becomes more uniform in the in-plane direction. It is desirable that the number of components may be reduced as compared with the first embodiment and the manufacturing process may be simplified.

### Third Embodiment

A third embodiment differs from the first and the second embodiments in a configuration between the element and the acoustic lens 201. In the present embodiment, a light reflective film 202 is formed on a film 203 as a support layer. Description of the same configurations as those of the first and the second embodiments will be omitted.

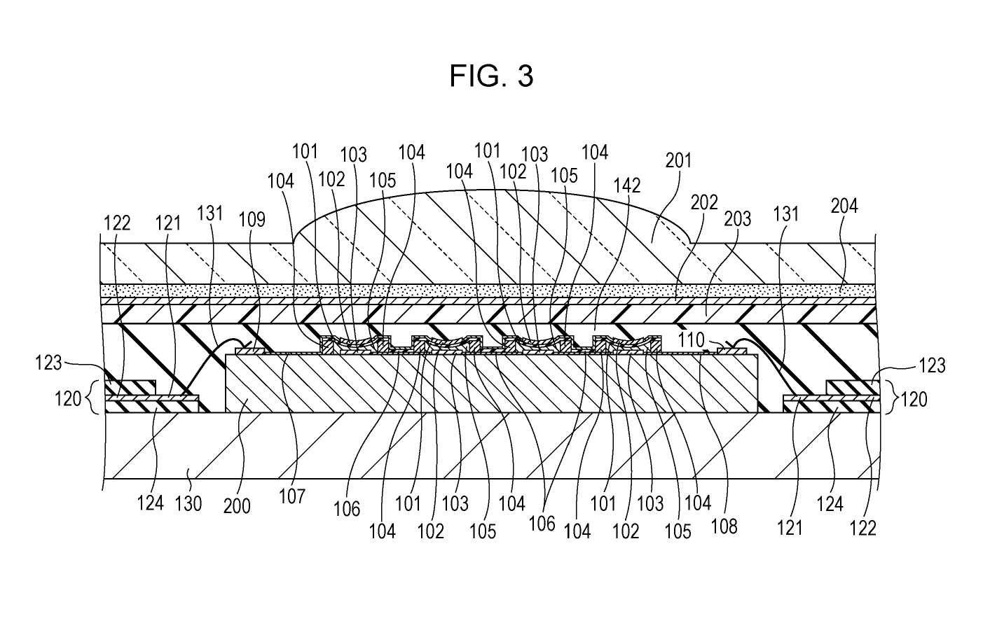

FIG. 3 is a schematic diagram illustrating a cross section of the probe of the present embodiment. In the present embodiment, an acoustic matching layer 142 is disposed on an element chip 200, a film 203 is formed thereon, and the light reflective film 202 is formed on the film 203. The acoustic lens 201 is disposed on the light reflective film 202 via an adhesive layer 204.

In the present embodiment, the film 203 having high surface smoothness produced by drawing is used as a support layer of the light reflective film 202 and the light reflective film 202 is formed on the film 203. In this case, variation in thickness of the film 203 produced by drawing may be reduced to equal to or less than ±10%. Therefore, reflectance may be increased even if the thickness of the light reflective film 202 is small since surface smoothness is high. Since the thickness of the light reflective film 202 may further be reduced, an influence on the transmission and reception characteristics may further be reduced. The effect of the film 203 is not limited to the surface smoothness. For example, there is an effect of reducing bending or deformation of the light reflective film 202 as compared with a case in which the light reflective film 202 is formed on the acoustic matching layer 142. In this case, it is desirable that the film 203 has the Young's modulus higher than that of the acoustic matching layer 142. Specifically, the Young's modulus is desirably from equal to or greater than 100 MPa to equal to or less than 20 GPa. The acoustic impedance of the film 203 is desirably close to those of the acoustic matching layer 142 and the acoustic lens 201. Specifically, the acoustic impedance is desirably from equal to or greater than 1 MRayls to equal to or less than 5 MRayls and, more desirably, from equal to or greater than 1 MRayls to equal to or less than 3 MRayls.

The film 203 of the present embodiment may be any film on which the light reflective film 202 may be directly formed. The film 203 may be made of PET, polypropylene, polyethylene and other materials. The thickness of the film 203 is from about 1 μm to about 30 μm.

The light reflective film 202 is formed on the film 203 in advance. The film 203 with the light reflective film 202 formed thereon may be easily disposed by bonding on the element chip 200 via the acoustic matching layer 142. Then, the side on which the light reflective film 202 of the film 203 is formed is bonded to the acoustic lens 201 by the adhesive layer 204.

In the present embodiment, it is desirable that, since the film 203 on which the light reflective film 202 is formed is provided, the flexible wiring substrate 120 and an end portion of the element chip 200 may be efficiently covered with the light reflective film 202.

### Fourth Embodiment

A fourth embodiment includes a protective layer 205 instead of the acoustic lens 201. Other configurations are the same as those of any one of the first to the third embodiments and, therefore, description thereof will be omitted.

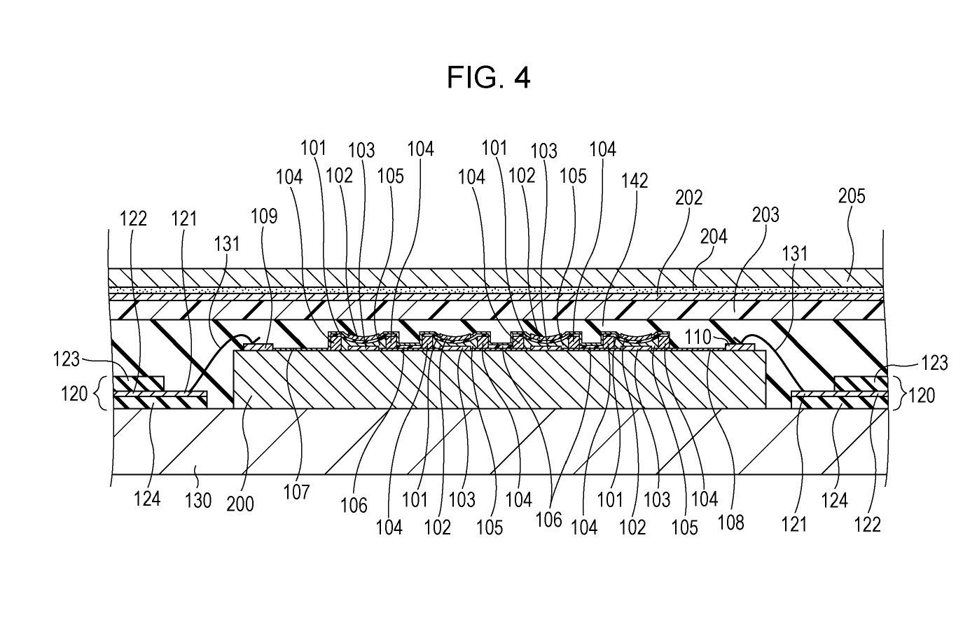

FIG. 4 is a schematic diagram of a cross section of a probe of the present embodiment. In the present embodiment, a protective layer 205 is disposed instead of an acoustic lens 201 on a front surface side of an element chip 200. An acoustic impedance of the protective layer 205 is desirably close to those of a sample or neighboring media and, specifically, desirably from equal to or greater than 1 MRayls to equal to or less than 2 MRayls. More desirably, the acoustic impedance is around 1.5 MRayls (i.e., in an error range of the acoustic impedance of equal to or less than ±10% of 1.5 MRayls).

It is desirable that the protective layer 205 of the present embodiment is transparent to light of a wavelength band used to generate a photoacoustic wave. That is, it is desirable to let light of the used wavelength band pass through without being absorbed. In particular, the protective layer 205 of the present embodiment has transmittance of light of a wavelength band used to generate a photoacoustic wave is desirably equal to or greater than 80% and, more desirably, equal to or greater than 90%.

The protective layer 205 of the present embodiment has an absorption coefficient of less than 0.2 mm⁻¹ in the wavelength band of light used. Therefore, light absorbed when the thickness of the protective layer 205 is 0.5 mm may be reduced to about 20%. The protective layer 205 of the present embodiment desirably has an absorption coefficient less than 0.1 mm⁻¹ in the wavelength band of light used. Therefore, light absorbed when the thickness of the protective layer 205 is 0.5 mm may be reduced to about 10%.

An absorption coefficient of hemoglobin which is a typical optical absorber (i.e., an inspection target by a photoacoustic wave) to a light wavelength bandwidth of about 600 nm to about 1000 nm which is considered to be a wavelength band of light used is from equal to or greater than 0.3 mm⁻¹ to equal to or less than 0.9 mm⁻¹. Also from this viewpoint, it is desirable to set the absorption coefficient of the protective layer 205 to less than 0.2 mm⁻¹, whereby the absorption coefficient of the protective layer 205 becomes smaller than the absorption coefficient of hemoglobin. Since laser light having a peak on a predetermined wavelength is used in many cases for generating a photoacoustic wave, in this case, an absorption coefficient of the protective layer 205 indicates to be less than 0.2 mm⁻¹ on the peak wavelength.

More desirably, the absorption coefficient of the protective layer 205 of the present embodiment is less than 0.01 mm⁻¹. This may reduce light absorbed by the protective layer 205 to about less than 1%. An optical absorption coefficient of a living body (i.e., adipose tissues) is from equal to or greater than about 0.005 mm⁻¹ to equal to less than about 0.02 mm⁻¹ in a light wavelength bandwidth of 600 nm to 1100 nm. Also from this viewpoint, by setting the optical absorption coefficient of the protective layer 205 to substantially the same or below the optical absorption coefficient of the sample, signals which become a noise component to the photoacoustic wave from the optical absorber which is an inspection target may be reduced.

As materials of the protective layer 205, silicone rubber having polydimethylsiloxane (PDMS) as a principal component crosslinked with an organic polymer, and resin are desirably used. PDMS to which silica particles are added and fluorosilicone of which hydrogen of PDMS is partially replaced with fluoride may also be used. Resin, such as PET, polypropylene, polyethylene, may also be used.

Since the protective layer 205 is provided on the front surface as in the present embodiment, damage to the light reflective film 202 may be avoided and a decrease in a reduction effect of noise generation by light may be reduced.

Although the present embodiment does not include an acoustic lens, electronic focusing may be performed by adjusting a delay amount of the transmission signals input in each element. Although a configuration in which the acoustic lens 201 of the third embodiment is changed to the protective layer 205 has been described in the foregoing description, the present embodiment is not limited to the same and may also be applied to the configurations of the first and the second embodiments.

According to the present embodiment, even in a case in which the ultrasonic wave is transmitted and received without using an acoustic lens, generation of noise by incident light may be reduced without significantly impairing transmission and reception characteristics.

### Fifth Embodiment

A fifth embodiment differs from the fourth embodiment in the relationship between a protective layer and a light reflective film 202. Other configurations are the same as those of the fourth embodiment and, therefore, description thereof will be omitted.

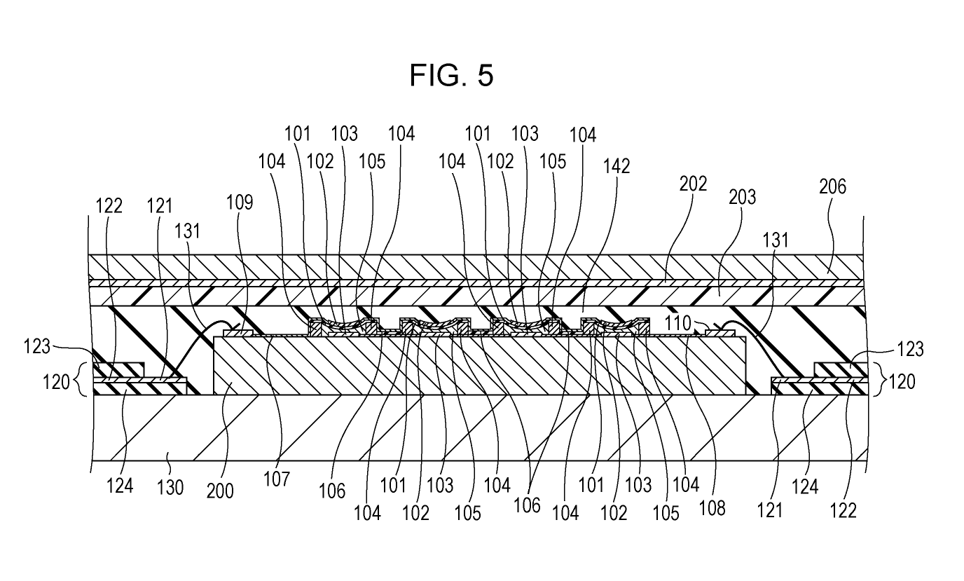

FIG. 5 is a schematic diagram of a cross section of a probe of the present embodiment. In the present embodiment, the light reflective film 202 is formed directly on an element chip side of a film-shaped protective layer 206 on which the light reflective film 202 is formed. The probe is easily configured by fixing, by the acoustic matching layer 142, the protective layer 206 on which the light reflective film 202 is formed with the light reflective film 202 side facing the element chip 200 side. It is desirable that the protective layer 206 transmits the light applied thereto as in the case in the fourth embodiment without absorbing the light. It is desirable that an acoustic impedance of the protective layer 206 is close to that of the sample and neighboring media.

It is desirable to use a protective layer 206 having high surface smoothness as that of the film 203 of the third embodiment. By forming the light reflective film 202 on the protective layer 206 having high surface smoothness, reflectance may be increased even if the thickness of the light reflective film 202 is small. Therefore, the thickness of the light reflective film 202 may further be decreased and an influence of the ultrasonic wave on the transmission and reception characteristics may further be reduced.

Further, by making the light reflective film 202 side face the element chip 200 side, it is possible that the protective layer 206 itself has a function as both a support member for forming the light reflective film 202 and a function for protecting the surface. Since an adhesive layer 204 is unnecessary, reflection characteristics are further improved and an influence on the transmission and reception characteristics is further reduced as compared with the fourth embodiment.

### Sixth Embodiment

A sixth embodiment differs from the first to the fifth embodiments in that a light reflective film 202 is disposed also on a surface of an acoustic lens 201 on a sample side. Other configurations are the same as those of any of the first to the fifth embodiments and, therefore, description thereof will be omitted.

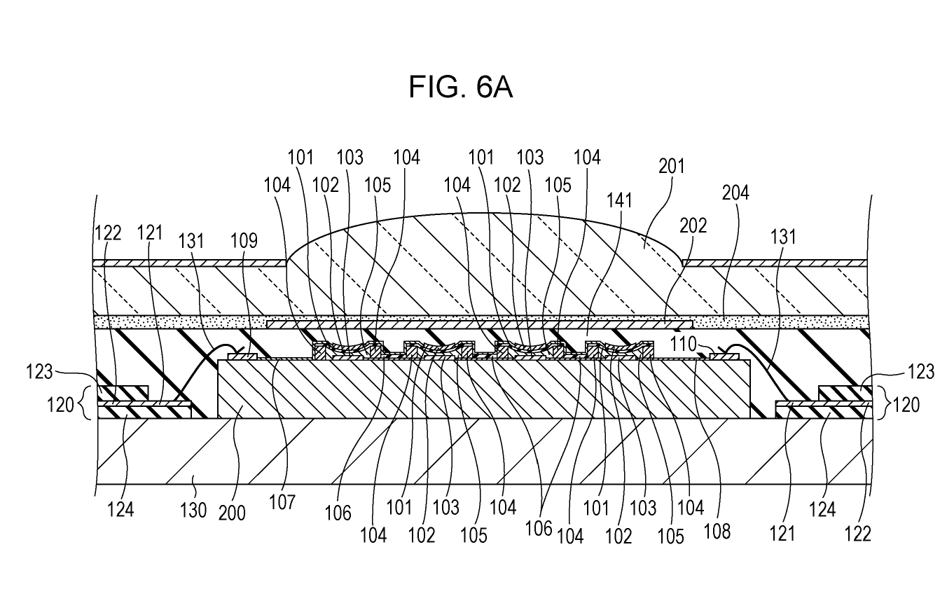

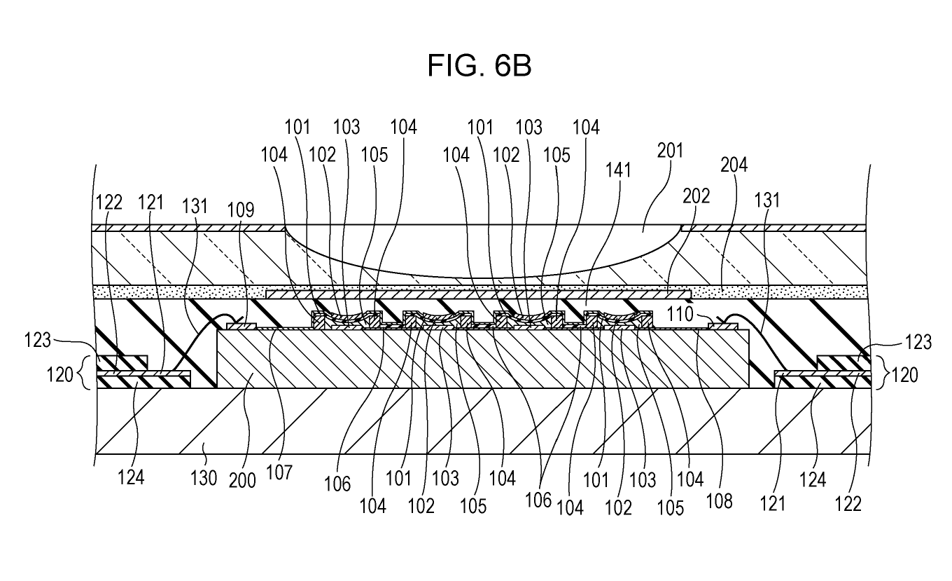

FIG. 6A is a schematic diagram illustrating a cross section of a probe of the present embodiment. In the probe of the present embodiment, in an area in which an element is formed, the light reflective film 202 is disposed on an element chip 200 side (i.e., a back side) of the acoustic lens 201. That is, the light reflective film 202 is disposed between the acoustic lens 201 and the element in an area which overlaps a convex portion of the acoustic lens 201 (i.e., an area including a range of the convex portion) in orthogonal projection to a substrate surface. In an area in which the element is not formed, the light reflective film 202 is disposed on the side opposite to the element chip 200 of the acoustic lens 201 (i.e., a front side which is a sample side). That is, in orthogonal projection to the substrate surface, the light reflective film 202 is provided on the surface opposite to the element chip 200 of the acoustic lens 201 in an area which does not overlap the convex portion of the acoustic lens 201.

Here, the light reflective film 202 on the front side of the acoustic lens 201 and the light reflective film on the back side partially overlap in orthogonal projection to the substrate surface 202. Therefore, it is possible to prevent the light from passing through between the light reflective films and reaching the element.

In the present embodiment, in an area in which the element is formed, a distance between the light reflective film 202 and the element may be shortened, and the distance between the light reflective film 202 and the element becomes uniform in an in-plane direction. In an area in which the element is not formed, since the light reflective film 202 is disposed on a surface of the acoustic lens 201, light does not enter members disposed below the acoustic lens 201 (i.e., the element side), such as an adhesive layer 204. That is, a very small amount of photoacoustic wave generated by absorption of light in the adhesive layer 204 and the like may also be reduced.

The light reflective film 202 may be selectively formed on the front side of the acoustic lens 201 easily by forming a film using, for example, a stencil mask.

The present embodiment may be used not only in the convex acoustic lens 201 but in a concave acoustic lens 201 as illustrated in FIG. 6B. Further, the present embodiment is not limited to a configuration in which the acoustic lens 201 is used, but may be applied also to a configuration in which a protective layer described in the fourth and the fifth embodiment is disposed.

### Seventh Embodiment

A seventh embodiment includes a housing 301 (i.e., an outer frame of a probe) for containing an element chip 200, and a light reflective film is disposed also on a surface on the sample side of the housing 301. Other configurations are the same as those of any of the first to the sixth embodiments and, therefore, description thereof will be omitted.

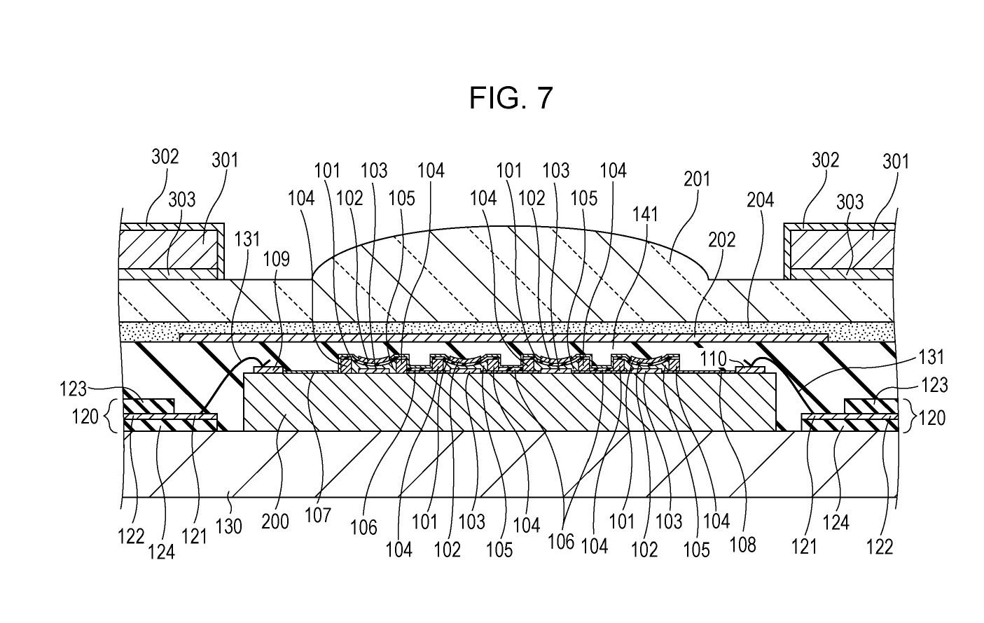

FIG. 7 is a schematic diagram illustrating a cross section of the probe of the present embodiment. In FIG. 7, the element chip 200 and the like are disposed inside the housing 301. Although the light reflective film 202 is formed directly on an acoustic matching layer 141 in FIG. 7, the present embodiment is not limited to this configuration. In the present embodiment, a light reflective film 302 is provided on a surface on the sample side of the housing 301, and the surface on the sample side of the housing 301 is covered with the light reflective film 302 so as not to be exposed. The light reflective film 302 may reduce the photoacoustic wave generated from the housing 301. The light reflective film 302 may be made of materials similar to those of the light reflective film 202.

However, since the light reflective film 302 on the housing 301 needs not transmit an ultrasonic wave and a photoacoustic wave, it is only necessary that a thickness of the light reflective film 302 satisfies only conditions of reflection characteristics of light. That is, the light reflective film 302 may be thicker than the light reflective film 202. Therefore, a light reflective film produced by laminating a plurality of resin layers may be used as the light reflective film 302. In a case in which resin is used, since the resin is not easily damaged as compared with a metal film even if the resin is disposed on the surface, it is not necessary to add a member to the sample side of the light reflective film 302 to protect the surface, optical reflectance is not impaired.

It is only necessary that the light reflective film 202 disposed on the element is disposed to partially overlap the housing 301 in orthogonal projection to the substrate surface and, therefore, it is not necessary to be disposed on the entire surface of the housing 301. Therefore, the light reflective film 202 which affects the transmission and reception characteristics of the ultrasonic wave may be disposed in the minimum area without any restrictions of other areas.

### Eighth Embodiment

In an eighth embodiment, an acoustic lens 201 is disposed in an area divided by a housing 301. Other configurations are the same as those of the third embodiment and, therefore, description thereof will be omitted.

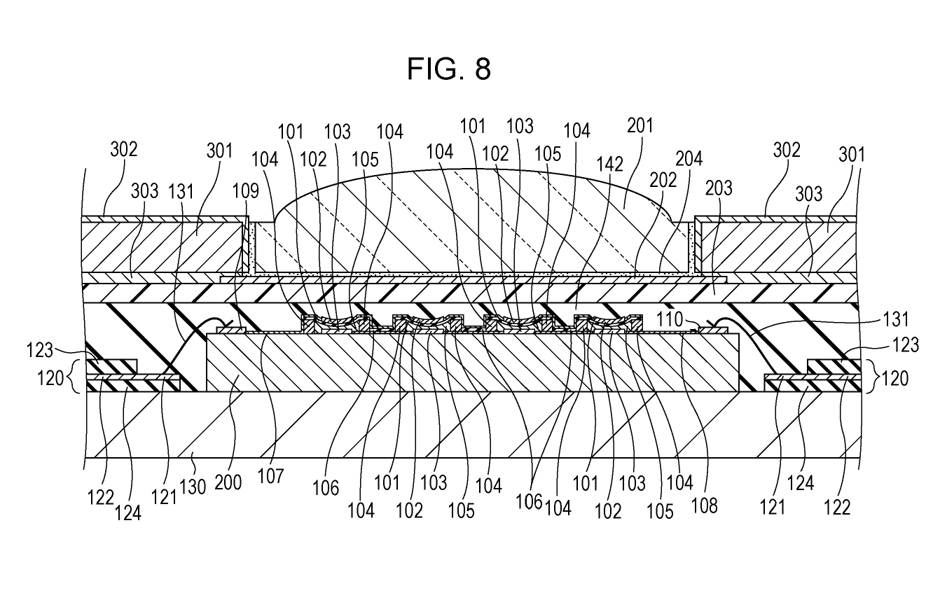

FIG. 8 is a schematic diagram illustrating a cross section of a probe of the present embodiment. Although a configuration in which the light reflective film 202 is formed on a film 203 and an acoustic matching layer 142 is provided between the film 203 and an element chip 200 is described in FIG. 8, the present embodiment is not limited to the same. In the present embodiment, the shape of the acoustic lens 201 differs from those of other embodiments and the acoustic lens 201 is disposed only on the element chip 200. In an area on a flexible wiring substrate in which the acoustic lens 201 is not disposed, a housing 301 in which the light reflective film 302 is formed on the surface on the sample side and a side surface on the lens side is disposed.

The light reflective film 202 disposed on the surface of the element chip side (i.e., the back surface) of the acoustic lens 201 is disposed to be slightly larger so as to have an area overlapping the acoustic lens 201 in orthogonal projection to the substrate surface. In the present embodiment, since in an upper portion of the element may be covered substantially perfectly with the light reflective film 202 and the light reflective film 302, incident light may be substantially reflected on the light reflective films. Therefore, light reflection efficiency is improved and generation of noise by light may be made extremely small.

The present embodiment may be manufactured easily in the following exemplary procedure. First, the film 203 on which the light reflective film 202 is partially formed is aligned with the element chip 200 and is bonded to the element chip 200 via the acoustic matching layer 142. Then, the housing 301 provided with the light reflective film 302 on the front surface and the side surface is bonded to the film 203 using an adhesive layer 303 with reference to the light reflective film 202 on the film 203. Finally, the acoustic lens 201 is bonded to the film 203 and the housing 301 using an adhesive layer 204. At this time, since a positional relationship between the housing 301 and the element chip 200 has been adjusted, the acoustic lens 201 may be bonded with the position with respect to the element chip 200 being aligned correctly.

### Ninth Embodiment

A ninth embodiment will be described with reference to FIG. 9. The present embodiment relates to a sample information acquisition device provided with the probe described in any one of the first to the eighth embodiments. In particular, the present embodiment relates to a sample information acquisition device 400 which uses a photoacoustic effect.

In a sample information acquisition device 400 illustrated in FIG. 9, light 501 (i.e., pulsed light) emitted from a light source 401 in accordance with light emission instruction signals 503 is applied to a sample 402. Within the sample 402, a photoacoustic wave 502 is generated from an inspection target which has absorbed the light 501. A probe 403 receives the photoacoustic wave 502 and outputs reception signals 504. The reception signals 504 are input in an image information generating device 404 which is a processing unit. The image information generating device 404 performs signal processing based on information about size, shape and time of the reception signals 504 and information about size, shape and time of the light 501 emitted from the light source 401 (i.e., light emission information). Specifically, the image information generating device 404 generates image signals indicating characteristic information within the sample 402 by performing image reconstruction based on the reception signals 504 and the light emission information, and outputs the generated image signals as reconstruction image information 505. An image based on the photoacoustic wave generated by the image information generating device 404 is displayed by a display device 405.

The characteristic information obtained by the photoacoustic wave reflect absorptivity of the optical energy. Specific examples of the characteristic information obtained by the photoacoustic wave include characteristic information reflecting initial sound pressure of the generated photoacoustic wave, optical energy absorption density that is derived from the initial sound pressure, absorption coefficient, concentration of substances which constitute the tissues, and the like. Concentration of substances is, for example, oxygen saturation, total hemoglobin concentration, oxyhemoglobin concentration or deoxyhemoglobin concentration. Image data is generated by obtaining characteristic information of a plurality of positions as two-dimensional or three-dimensional characteristic distribution.

The sample information acquisition device of the present embodiment may reduce generation of noise by light from the light source by using the probe of any one of the first to the eighth embodiments and may generate an image with little image quality deterioration by noise.

### Tenth Embodiment

A tenth embodiment will be described with reference to FIG. 10. The present embodiment relates to a sample information acquisition device in which a probe described in any one of the first to the eighth embodiments is used. In particular, the sample information acquisition device of the present embodiment performs not only reception of a photoacoustic wave but transmission and reception of an ultrasonic wave using a photoacoustic effect. That is, in addition to the configuration and the operation of the ninth embodiment, the sample information acquisition device of the present embodiment performs transmission of an ultrasonic wave and reception of a reflected wave, and obtains characteristic information within the sample based on the reception signals of the reflected wave.

The sample information acquisition device of the present embodiment will be described with reference to FIG. 10. In the present embodiment, an ultrasonic wave 506 is output (i.e., transmitted) toward a sample 402 from a probe 403 in accordance with transmission signals 508. Within the sample 402, the ultrasonic wave 506 is reflected due to a difference in a specific acoustic impedance on an inspection target. The reflected wave 507 is received by the probe 403, and reception signals 509 are output from the probe 403. The reception signals 509 are input in the image information generating device 404 which is a processing unit. The image information generating device 404 performs signal processing based on information about size, shape and time of the reception signals 509 and information about the transmission signals 508 (i.e., transmission information). Specifically, the image information generating device 404 generates image signals indicating characteristic information within the sample 402 by performing image reconstruction based on the reception signals 509 and the transmission information, and outputs the generated image signals as reconstruction image information 505. An image based on the photoacoustic wave generated by the image information generating device 404 and the image based on transmission and reception of the ultrasonic wave is displayed by a display device (not illustrated).

The characteristic information obtained from the reception signals of the reflected wave reflects a difference in an acoustic impedance in the sample. Specific examples of the characteristic information obtained from the reflected wave include form information reflecting an acoustic impedance difference within the sample, information indicating elasticity of and viscosity of tissues, and movement information, such as a blood flow rate, which are derived from the acoustic impedance difference. Image data may be generated by obtaining characteristic information of a plurality of positions as two-dimensional or three-dimensional characteristic distribution.

The sample information acquisition device of the present embodiment may reduce generation of noise by light by using the probe of any one of the first to the eighth embodiments. The transmission and reception characteristics of the ultrasonic wave are not changed significantly. Therefore, high quality images with little image quality deterioration may be created.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-257165, filed Dec. 12, 2013 which is hereby incorporated by reference herein in its entirety.

What is claimed is:

1. A probe comprising:
an element configured to receive an acoustic wave generated within a sample upon irradiation of light;
a first light reflective film; and
an acoustic lens,
wherein the first light reflective film is provided between the element and the acoustic lens and reflects light of a bandwidth including a wavelength of light with which the sample is irradiated.

2. The probe according to claim 1, wherein the acoustic lens has transmittance of the light of equal to or greater than 80%.

3. The probe according to claim 2, wherein the acoustic lens has transmittance of the light equal to or greater than 90%.

4. The probe according to claim 1, wherein the acoustic lens has an absorption coefficient of the light of less than 0.01 mm⁻¹.

5. The probe according to claim 1, further comprising a second light reflective film provided on a surface opposite to a side of the element side of the acoustic lens and in an area in which the element is not provided in an orthogonal projection to a surface on which the element is provided.

6. The probe according to claim 1, wherein the element includes a cell in which a vibration membrane including one of a pair of electrodes provided across a gap is vibrationally supported.

7. The probe according to claim 1, wherein the first light reflective film has reflectance of light of the bandwidth of equal to or greater than 80%.

8. The probe according to claim 1, further comprising an acoustic matching layer provided between the element and the first light reflective film.

9. The probe according to claim 8, further comprising a support layer configured to support the first light reflective film, the support layer being provided between the first light reflective film and the acoustic matching layer.

10. The probe according to claim 1, wherein, in orthogonal projection to a surface on which the element is provided, orthogonal projection of the plurality of elements is included in orthogonal projection of the first light reflective film.

11. The probe according to claim 1, further comprising a housing configured to contain the element and comprising a third light reflective film on a surface on the sample side of the housing.

12. The probe according to claim 1, wherein the element transmits an acoustic wave and receives a reflected wave of the transmitted acoustic wave reflected within the sample.

13. A sample information acquisition device, comprising:
the probe according to claim 1; and
a processing unit,
wherein the probe receives an acoustic wave generated within the sample and outputs a first reception signal, and the processing unit obtains a first characteristic information of the sample using the first reception signal.

14. The sample information acquisition device according to claim 13, wherein
the probe receives a reflected wave of an acoustic wave transmitted to the sample and reflected within the sample, and outputs a second reception signal, and
the processing unit obtains second characteristic information of the sample using the second reception signal.

15. A probe, comprising:
an element configured to receive an acoustic wave generated within the sample upon irradiation of light;
a first light reflective film; and
a protective layer,
wherein
the first light reflective film is provided between the element and the protective layer and reflects light of a bandwidth including a wavelength of light with which the sample is irradiated.

16. The probe according to claim 15, wherein the protective layer has transmittance of the light equal to or greater than 90%.

17. The probe according to claim 15, wherein the protective layer has a absorption coefficient of the light of less than 0.01 mm⁻¹.

18. The probe according to claim 15, further comprising a second light reflective film provided on a surface opposite to a side of the element side of the protective layer and in an area in which the element is not provided in an orthogonal projection to a surface on which the element is provided.

19. The probe according to claim 15, wherein the first light reflective film has reflectance of light of the bandwidth of equal to or greater than 80%.

20. The probe according to claim 15, further comprising an acoustic matching layer provided between the element and the first light reflective film.

21. The probe according to claim 20, further comprising a support layer configured to support the first light reflective film, the support layer being provided between the first light reflective film and the acoustic matching layer.

22. The probe according to claim 15, wherein orthogonal projection of the plurality of elements is included in orthogonal projection of the first light reflective film in orthogonal projection to a surface on which the element is provided.
